(19) United States
(12) Patent Application Publication
(10) Pub. No.: US 2025/0034008 A1
(43) Pub. Date: Jan. 30, 2025

(54) APPARATUS FOR FILTERING CHARGED PARTICLES USING ELECTROKINETIC

(71) Applicants: Postech Academy-Industry Foundation, Pohang-si (KR); SNTEL Co., LTD, Pohang-si (KR)

(72) Inventors: Geun bae Lim, Gyeongju-si (KR); Min Soo LEE, Pohang-si (KR); Woon Jae CHOI, Bucheon-si (KR)

(73) Assignees: Postech Academy-Industry Foundation, Pohang-si (KR); SNTEL Co., LTD, Pohang-si (KR)

(21) Appl. No.: 18/461,269

(22) Filed: Sep. 5, 2023

(30) Foreign Application Priority Data
Jul. 24, 2023 (KR) 10-2023-0096040

(51) Int. Cl. C02F 1/469; C02F 1/42; C02F 1/44

(52) U.S. Cl. CPC C02F 1/4696; C02F 1/42; C02F 1/441; C02F 2101/30

(57) ABSTRACT

The present disclosure discloses an electrokinetic-based apparatus for filtering charged particles. The apparatus includes a main channel through which a fluid containing charged particles is injected and flows, a first electrode disposed to allow the flow of fluid inside the main channel, and an ion exchange membrane disposed downstream of the first electrode and having a plurality of pores through which the fluid from which the charged particles have been filtered is discharged.

### TECHNICAL FIELD

The present disclosure relates to a filtering apparatus, and, more particularly, to an electrokinetic-based filtering apparatus. More specifically, but not exclusively, the present disclosure relates to an electrokinetic-assisted filtration technique for rapidly and efficiently removing charged particles such as microplastics from water.

### BACKGROUND

Water disposal, including the disposal of sewage or industrial wastewater, is considered very important in a wide range of fields. Fluid to be filtered may contain substances of various properties, but filtration of charged particles may be required, for example. Plastics may be typical charged particles to be filtered.

In recent years, plastic pollution has become one of the major environmental problems and the relevant concerns are only growing. With the steady increase in plastic use, annual global plastic production is now reaching about 400 million tons, a mass projected to reach about 800 million tons by 2050. The problem here is that plastics are impervious to decay. As taking at least decades to hundreds of years to fully decompose, spent plastics have been constantly accumulating in the ecosystem. Meanwhile, discarded plastic debris shed tiny specks of various shapes by mechanical or chemical processes, of which specks smaller than 5 mm are called microplastics (MPs). MPs flow into the entire aquatic environments including rivers and seas, remaining floating in water for a long time due to their chemical stability. As a result, humans and animals as well as aquatic organisms are inevitably exposed to MPs, raising ecological and environmental hazards.

In addition, MPs are easily capable of adsorbing organic chemical pollutants such as bacteria, heavy metals, and pharmaceutical compounds due to their high specific surface area and hydrophobicity, causing harmful impacts on human health as people intake contaminated MPs through the food chain. Especially, extremely tiny plastic specks smaller than 1 μm, called nano plastics (NPs), can enter cells or tissues, potentially incurring inflammation and adversely affecting cellular activities.

Among diverse engineered separation and degradation technologies, membrane filtration (MF) is currently regarded as a promising strategy that can successfully remove MPs from aquatic environments. Based on the size exclusion mechanism, it is viable to effectively retain various-sized MPs through MF simply by adjusting the pore size of a membrane filter. Recent studies have confirmed that MF shows more effective MPs removal performance compared to conventional water treatment processes (e.g. rapid sand filtration, dissolved air filtration, oxidation ditch). So far, different kinds of membranes as an effective alternative to existing polymeric membranes have been developed especially for MPs removal.

Despite its outstanding MPs removal performance, an intrinsic tradeoff between removal efficiency and flux makes MF inappropriate for reliable industrial application. In general, a pressure of several bars is applied to membrane filters with an average pore size of about 1 μm to achieve a flux of hundreds L m⁻²h⁻¹. However, employing a membrane filter with finer pore size to separate even tinier particles further intensifies transmembrane pressure drop, requiring substantially high energy consumption to secure the same level of flux.

Along with the efficiency-flux trade-off, membrane fouling is an unavoidable challenge in MF. The membrane fouling causes severe flux decline and affects the quality of water produced, eventually provoking several economic and operational issues. Moreover, MF has some difficulty in the removal of fiber MPs which are the most dominant shape of MPs present in aquatic environments due to their longitudinal penetration into small gaps or pores of membrane filters.

Therefore, a practical approach to remedy these drawbacks is ultimately needed for complete MPs removal from aquatic environments.

### SUMMARY

The purpose of the present disclosure to solve the aforementioned problems is to provide an electrokinetic-based apparatus for filtering charged particles, capable of filtering even substances having a fine size or fibrous form, which are difficult to remove by a conventional membrane filtration, by filtering charged particles based on electrokinetic and preventing contamination of a membrane.

Another purpose of the present disclosure is to provide an electrokinetic-based apparatus for filtering charged particles, capable of achieving high removal efficiency for substances to be filtered by using electrokinetic for filtration while preventing excessive energy consumption for reducing or maintaining the flow rate of fluid.

However, the problems to be solved by the present disclosure are not limited thereto, and many more problems may be resolved by the present disclosure within the technology and the scope of the present disclosure.

To achieve the above-mentioned purposes, an electrokinetic-based apparatus for filtering charged particles according to an example of the present disclosure may include: a main channel through which a fluid containing charged particles is injected and flows; a first electrode disposed to allow the flow of fluid inside the main channel; and an ion exchange membrane disposed downstream of the first electrode and having a plurality of pores through which the fluid from which the charged particles have been filtered is discharged.

According to an example of the present disclosure, the first electrode and the ion exchange membrane may generate an electric field therebetween.

According to an example of the present disclosure, a polarity different from that of charged particles to be filtered may be applied to the first electrode, the ion exchange membrane may be an ion exchange membrane for ions of a polarity different from that of charged particles to be filtered, and a second electrode having the same polarity as charged particles to be filtered may be connected to the ion exchange membrane.

According to an example of the present disclosure, an ion depletion region may be formed upstream of the ion exchange membrane to block the movement of the charged particles into the pores of the ion exchange membrane.

According to an example of the present disclosure, the ion depletion region may be formed based on ion concentration polarization (ICP).

According to an example of the present disclosure, the first electrode may include an additional ion exchange membrane having a plurality of pores allowing the flow of fluid.

According to an example of the present disclosure, the ion depletion region may cause an electrophoretic force to act on the charged particles.

According to an example of the present disclosure, the charged particles may move in a direction different from a direction in which fluid flows by a drag force resulting from the flow of the fluid and the electrophoretic force.

According to an example of the present disclosure, the ion depletion region may include sub-ion depletion regions corresponding to each of the plurality of pores in the ion exchange membrane and may have a cross-sectional area equal to or larger than a predetermined first area in a direction in which fluid flows by including the plurality of sub-ion depletion regions.

According to an example of the present disclosure, the apparatus for filtering charged particles may further include a porous layer disposed upstream of the ion exchange membrane inside the main channel and designed to filter particles of a size equal to or larger than a predetermined first size among particles in fluid.

According to an example of the present disclosure, the porous layer may limit electroconvection induced in the ion depletion region to a predetermined level or less so that the ion depletion region may have a cross-sectional area equal to or larger than a predetermined second area in a direction in which fluid flows.

According to an example of the present disclosure, the electroconvection may be induced by electroosmotic instability.

According to an example of the present disclosure, the electroconvection may include a three-dimensional helical vortex pair.

According to an example of the present disclosure, the porous layer may be formed of polyester microfiber.

According to an example of the present disclosure, the apparatus for filtering charged particles may further include a dorm-shaped cap designed to fix the porous layer and allow the flow of fluid.

According to an example of the present disclosure, the upper boundary of the porous layer may be bent by the dorm-shaped cap so that the ion depletion region may have a convex shape.

According to an example of the present disclosure, the filtration efficiency of the apparatus for filtering charged particles may vary depending on at least one of the flow rate of fluid passing through the filtration apparatus, voltage applied to the first electrode and the ion exchange membrane, zeta potential of the charged particles, or the type of the charged particles.

According to an example of the present disclosure, the apparatus for filtering charged particles may be used to filter again fluid that has passed through a reverse osmosis-based filtration apparatus.

According to an example of the present disclosure, the apparatus for filtering charged particles may further include a branch channel diverging from the main channel upstream of the ion exchange membrane and allowing the charged particles to be discharged therethrough.

According to an example of the present disclosure, the charged particles may be sent to the branch channel by a resultant force of the electrophoretic force of the ion depletion region formed upstream of the ion exchange membrane and a drag force resulting from the flow of fluid.

The disclosed art may have the following effects. However, because it is not meant that a specific example must include all of the following effects or only include the following effects, it should not be understood that the scope of the disclosed art is limited thereto.

According to an example of the present disclosure described above, it may be possible for the electrokinetic-based apparatus for filtering charged particles to filter even substances having a fine size or fibrous form, which are difficult to remove by a conventional membrane filtration, by filtering charged particles based on electrokinetic and prevent contamination of a membrane.

In addition, it may be possible for the electrokinetic-based apparatus for filtering charged particles to achieve high removal efficiency for substances to be filtered by using electrokinetic for filtration while preventing excessive energy consumption for reducing or maintaining the flow rate of fluid.

### BRIEF DESCRIPTION OF THE DRAWINGS

FIG. 1 is a schematic view of an electrokinetic-assisted filtration system for removing charged particles from fluid.

FIG. 2 shows the kinematic relationship between a charged particle located at the edge of a main channel and a charged particle located at the center thereof.

FIG. 3 is a schematic view showing how an ion depletion region is formed in each of an ion exchange membrane alone and an ion exchange membrane-porous layer combination.

FIG. 4 shows a model experimental device for a filtering apparatus according to an example of the present disclosure.

FIG. 5 is an exploded view of the arrangement of main components of the device.

FIG. 6 is a side view of the experimental device in FIG. 4.

FIG. 7 shows an ion exchange membrane with a micro hole array and a porous layer covered with a dorm-shaped cap.

FIG. 8 shows the assembled experimental device.

FIG. 9 shows a comparison of MP removal performance shown by mathematical analysis and that shown in experimental results.

FIG. 10 shows three different filtration regimes distinguished by the relationship between voltage and flux.

FIG. 11 shows photographs and microscopic images of feed and filtrate of sampled PE microspheres that vary depending on voltage, and removal efficiency for the PE microspheres that varies depending on voltage.

FIG. 12 shows photographs and microscopic images of feed and filtrate of sampled PE microspheres that vary depending on flux, and removal efficiency for the PE microspheres that varies depending on flux.

FIG. 13 shows the proportion of particles of each size in feed and filtrate of PE microspheres for each voltage.

FIG. 14 shows the proportion of particles of each size in feed and filtrate of PE microspheres for each flux.

FIG. 15 shows photographs and microscope images of feed and filtrate under various pH conditions that vary depending on voltage and removal efficiency for PS microspheres under various pH conditions that varies depending on voltage.

FIG. 16 shows photographs and microscope images of feed and filtrate under various pH conditions that vary depending on flux and removal efficiency for the PS microspheres under various pH conditions that varies depending on flux.

FIG. 17 shows photographs and microscopic images of feed and filtrate of sampled PE, PS, and PP microspheres that vary depending on voltage and removal efficiency for the PE, PS and, PP microspheres that varies depending on voltage.

FIG. 18 shows photographs and microscopic images of feed and filtrate of sampled PE, PS, and PP microspheres that vary depending on flux and removal efficiency for the PE, PS, and PP microspheres that varies depending on flux.

FIG. 19 shows photographs and microscopic images of feed and filtrate of sampled PEST, acrylic, and nylon bundles that vary depending on voltage, and removal efficiency for the PEST, acrylic, and nylon bundles that varies depending on voltage.

FIG. 20 shows photographs and microscopic images of feed and filtrate of sampled PEST, acrylic, and nylon bundles that vary depending on flux, and removal efficiency for the PEST, acrylic, and nylon bundles that varies depending on flux.

### DETAILED DESCRIPTION

Since the present disclosure can include various changes and have various embodiments, specific embodiments are illustrated in the drawings and described in detail.

However, this is not intended to limit the present disclosure to specific embodiments, and should be understood to include all modifications, equivalents, and substitutes included in the spirit and scope of the present disclosure.

Terms such as first and second may be used to describe various components, but the components should not be limited by the terms. These terms are only used for the purpose of distinguishing one component from another. For example, a first component may be termed a second component, and similarly, a second component may be termed a first component, without departing from the scope of the present disclosure. The terms and/or include any combination of a plurality of related recited items or any of a plurality of related recited items.

It is understood that when a component is referred to as being “coupled” or “connected” to another component, it may be directly connected or connected to another element, but other components may exist in the middle. Meanwhile, when a component is referred to as “directly coupled” or “directly connected” to another component, it should be understood that no other element exists in the middle.

Terms used in the present disclosure are only used to describe specific embodiments, and are not intended to limit the present disclosure. Singular expressions include plural expressions unless the context clearly dictates otherwise. In the present disclosure, the terms “include” or “have” are intended to designate that there is a feature, number, step, operation, component, part, or combination thereof described in the specification, but it should be understood that the presence or addition of one or more other features, numbers, steps, operations, components, parts, or combinations thereof is not precluded.

Unless defined otherwise, all terms used herein, including technical or scientific terms, have the same meaning as commonly understood by one of ordinary skill in the art to which the present disclosure belongs. Terms such as those defined in commonly used dictionaries should be interpreted as having a meaning consistent with the meaning in the context of the related art, and unless explicitly defined in the present application, they should not be interpreted in an ideal or excessively formal meaning.

Hereinafter, with reference to the accompanying drawings, preferred embodiments of the present disclosure will be described in more detail. In order to facilitate overall understanding in the description of the present disclosure, the same reference numerals are used for the same components in the drawings, and redundant descriptions of the same components are omitted.

Since the embodiments described in the present disclosure are intended to clearly explain the spirit of the present disclosure to those skilled in the art to which the present disclosure belongs, the present disclosure is not limited by the embodiments described in the present disclosure, and the scope of the present invention should be construed to include modifications or variations that do not depart from the spirit of the present invention.

The terminology used in the present disclosure is a selection of general terms that are currently widely used as much as possible in the technical field to which the present disclosure belongs, but this may have different meanings depending on the intentions of those skilled in the art, customs, or the emergence of new technologies in the technical field to which the present invention belongs. However, in the case where a specific term is defined and used with an arbitrary meaning, the meaning of the term will be separately described.

Therefore, the terminology used in the present disclosure should be interpreted based on the actual meaning of the term and the general contents of the present disclosure, not the simple name of the term.

The drawings attached to the present disclosure are for easily explaining the present disclosure, the shapes illustrated in the drawings may be exaggerated or abbreviated as necessary to help the understanding of the present disclosure, and thus, the present disclosure is not limited by the drawings.

In the present disclosure, when it is determined that a detailed description of a known configuration or function related to the present disclosure may obscure the gist of the present disclosure, a detailed description thereof will be omitted if necessary.

### SUMMARY

Hereinafter, the description in the present disclosure focuses mainly on microplastics (MPs), which are examples of charged particles, for convenience of description. However, materials to be filtered according to the technology of the present disclosure are not limited to plastics, and it will be easily understood by a person having ordinary skill in the art that any charged particle can be filtered according thereto.

Among engineered degradation and separation methods for charged particles (e.g. microplastics (MPs)) removal from aquatic environments, membrane filtration (MF) relying on a size exclusion mechanism has shown potential for effective treatment of various-sized charged particles ranging from submicron to a few millimeters. However, basic concerns about MF involved in an inherent efficiency-flux trade-off and membrane fouling raise questions about its practical applicability.

Specifically, but non-limitedly, an electrokinetic-assisted filtration fulfilled by introducing electrokinetic assistance into physical filtration is proposed as a new candidate able to address the concerns of MF in the present disclosure. A filtration method according to an aspect of the present disclosure is founded on ion concentration polarization (ICP)-based electrokinetic manipulation of charged species, enabling to effectively block charged particles' downstream migration by inducing an electric force barrier in a fluid channel system.

As tiny charged particles passing through a filter lattice are electrically screened, the efficiency-flux trade-off is dramatically alleviated in the electrokinetic-assisted filtration system, allowing of a high removal efficiency of over 99.9% and a flux of 10,000 L m⁻²h⁻¹ simultaneously even without using fine filters. The filtration mechanism according to an aspect depends entirely on charged particles' electrophoretic mobility, thereby realizing consistent filtration performance for the same type of charged particles regardless of their sizes, shapes, and chemical compositions. Besides, it is not affected by the concentration of charged particles as well due to the nature of the force-based charged particles filtration mechanism.

Hereinafter, the theoretical background underlying the filtration method is comprehensively demonstrated using a scalable electrokinetic system. The fundamental working principle of the system according to an aspect of the present disclosure is investigated through parameter studies on core control variables (voltage and flux). As examples of charged particles, polyethylene microspheres with a distribution of different sizes ranging from hundreds of nanometers to hundreds of micrometers are used in parameter studies to closely verify the filtration mechanism according to an example of the present disclosure. The effect of charged particles' electrophoretic mobility on the system performance is subsequently examined. Further, the filtration performances of the system according to an aspect of the present disclosure for MPs with various types and shapes most frequently found in aquatic environments are systematically evaluated. Three types of MPs (polyethylene, PE; polystyrene, PS; polypropylene, PP) and three types of fiber MPs (polyester, PEST; Acrylic, Nylon) are chosen as exemplary model MPs.

### Electrokinetic-Assisted Filtration System

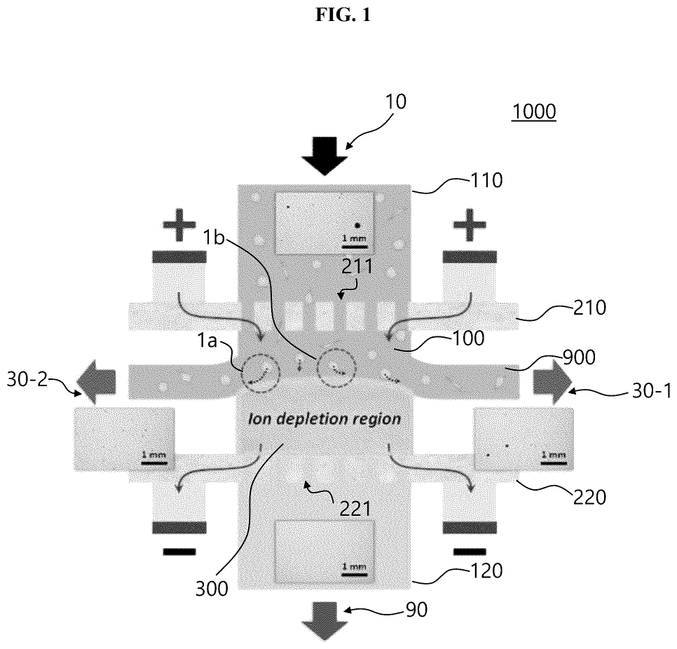

FIG. 1 is a schematic view of an electrokinetic-assisted filtration system for removing charged particles from fluid. Hereinafter, in the present disclosure, the filtration system may be referred to as a “filtration apparatus.” Hereinafter, with reference to FIG. 1, the operating principle of the electrokinetic-assisted filtration system according to an aspect of the present disclosure will be described in more detail.

The inventors of the present disclosure have devised the electrokinetic-based filtration system based on the fact that charged particles, such as MPs, actually have a surface charge when suspended in an electrolyte. The system may be formed as a hybrid filter system where an electrokinetic-assisted physical filtration is performed. As shown in FIG. 1, the system according to an example of the present disclosure may include a main channel 100 and buffer channels 110 and 120, and a first electrode 210 and an ion exchange membrane 220 may be arranged in the main channel 100. The first electrode 210 and the ion exchange membrane 220 may generate an electric field by allowing a current therebetween.

More specifically, but not exclusively, as shown in FIG. 1, an electrokinetic-based filtration apparatus 1000 may be provided according to an example of the present disclosure. A fluid 10 containing charged particles such as MPs may be introduced into the inlet of the buffer channel 110, and a fluid 90 from which the charged particles have been filtered may flow through the main channel 100 and may then be drained through the outlet of the buffer channel 120. According to an aspect of the present disclosure, the main channel 100 may be a main filtration path through which fluid containing charged particles is introduced and the fluid 90 from which the charged particles have been filtered is discharged. That is, the main channel 100 may serve as a path through which fluid containing charged particles is introduced and flows.

Inside the main channel 100, the first electrode 210 and the ion exchange membrane 220 for fluid flow may be disposed. The ion exchange membrane 220 may be disposed below the first electrode 210 and may have a plurality of pores 221 through which fluid from which charged particles have been filtered is discharged.

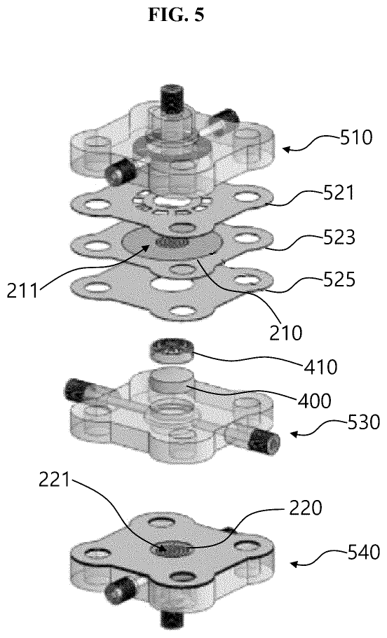

As mentioned above, the first electrode 210 may have a structure through which fluid can flow. For example, as shown in FIG. 1 or FIG. 5, the first electrode 210 may have a flat plate shape and have a plurality of pores 211 into which fluid containing charged particles is injected to allow the fluid to flow therethrough. In addition, according to an aspect of the present disclosure, the first electrode may be an ion exchange membrane having the plurality of pores 211 allowing fluid to flow. For example, the first electrode 210 formed as an ion exchange membrane according to the present disclosure may be distinguished from the ion exchange membrane 220 and referred to as an “additional ion exchange membrane 210.” However, the first electrode 210 according to the present disclosure is not limited to such a flat electrode or ion exchange membrane and may have any shape such as a rod or mesh shape to form an electric field by being opposed to the ion exchange membrane 220 while allowing fluid to flow inside the main channel.

Referring back to FIG. 1, the ion exchange membrane 220 may be disposed below the first electrode 210 and include the plurality of pores 221 through which fluid from which charged particles have been filtered is discharged. For example, to facilitate the flow of fluid inside the main channel, a microhole 211 may be formed in the first electrode 210, and a microhole 221 may be formed in the ion exchange membrane 220. The first electrode 210 and the ion exchange membrane 220 may physically allow fluid to flow inside the main channel 100 while generating current therebetween.

A branch channel 900 may be disposed in the middle of the main channel 100 to minimize the accumulation of charged particles in a physical filter 400 by continuously discharging the charged particles that have been repelled from an electric force barrier. The filtered charged particles may be discharged through outlets 30-1 and 30-2 of the branch channel 900. According to an aspect of the present disclosure, the branch channel 900 may diverge from the main channel 100 between the first electrode 210 and the ion exchange membrane 220 so that charged particles may be discharged therethrough. According to an aspect of the present disclosure, charged particles may be sent to the branch channel 900 through an ion depletion region 300 formed upstream of the ion exchange membrane 220, which will be described in detail below. According to an aspect of the present disclosure, the branch channel 900 may be a path that diverges from the main channel 100 and through which filtered charged particles are discharged.

According to an example of the present disclosure, a polarity different from that of charged particles to be filtered may be applied to the first electrode 210, the ion exchange membrane 220 may be an ion exchange membrane for ions of the polarity different from that of the charged particles to be filtered, and a second electrode having the same polarity as the charged particles to be filtered may be connected to the ion exchange membrane 220. That is, a polarity of voltages applied to the first electrode 210 and the ion exchange membrane 220, respectively, and/or the type of the ion exchange membrane 220, such as a cation exchange membrane or an anion exchange membrane, may depend on a polarity of charged particles to be filtered.

As a non-limiting example, FIG. 1 shows how polarities are connected for negatively charged MPs. As shown in FIG. 1, according to an example of the present disclosure for filtering negatively charged particles such as MPs, an anode may be applied to the first electrode 210, and a cathode may be connected to the ion exchange membrane 220. That is, the first electrode 210 itself may be an electrode to which an anode is applied or an electrode material connected to an anode, a cathode may be connected to the ion exchange membrane 220 on the downstream side, and the ion exchange membrane 220 may be a cation exchange membrane (CEM). According to an aspect of the present disclosure, the first electrode 210 may also be a cation exchange membrane (CEM) having the plurality of micro holes 211, but it should be noted that it is not limited thereto. The inlet and the outlet of the main channel 100 and the branch channel 900 may be electrically floated. In this example, ion concentration polarization (ICP) may occur on both sides of the ion exchange membrane due to a difference in ion mobility between a bulk solution and a nanochannel. As a result, the ion depletion region 300 may be formed upstream of the ion exchange membrane 220, in other words, in a direction toward the anode of the ion exchange membrane 220. That is, the ion depletion region may be formed based on ion concentration polarization.

The ion depletion region, where there are few ions, may be considered as electrical resistance and act as an electrical force barrier preventing the movement of ions. Therefore, the ion depletion region 300 may block the movement of charged particles such as MPs to the pore 221 of the ion exchange membrane 220. More specifically, the ion depletion region 300 may cause electrophoretic force to act on charged particles such as MPs. Accordingly, charged particles may move in a direction different from a direction in which fluid flows by a drag force resulting from the flow of the fluid and an electrophoretic force.

The movement behavior of charged particles in a fluid may be governed by the Stokes' law because the particle Reynolds number is very low (Reₚ<<1). For example, in the case of anionic spherical charged particles, drag force and electrophoretic force may mainly act on the charged particle, and a velocity component may be given as shown in Equations (1) and (2) below.

$${u}_{drag} ( t ) = \frac{( ρ - {ρ}_{0} ) Vg}{6 πη r} ( 1 - {e}^{- 6 πη rt / m} ) \qquad ( 1 )$$

$${u}_{ep} = \frac{{ε}_{0} {ε}_{r} ζ E}{η} , \qquad ( 2 )$$

where ρ is the density of a particle, ρ₀ is the density of fluid, V is the volume of a particle, g is a gravitational acceleration, m is the mass of a particle, n is the dynamic viscosity of fluid, and r is the Stokes radius of a particle. In addition, ε₀ is the permittivity of free space, εᵣ is a relative permittivity, ζ is a zeta potential, and E is an electric field. Here, it can be assumed that the drag velocity is equal to the velocity of fluid.

$${u}_{f} = Q / A , \qquad ( 3 )$$

where Q is a flow rate, and A is the cross-sectional area of a channel. Because the relaxation time (τₚ˜10⁻⁴-10⁻² seconds) of micrometer-sized particles in fluid is very short, it can be assumed that the drag velocity is equal to the velocity of fluid. As a result, charged particles approaching the ion depletion region may have a forward drag velocity component, a drag velocity component in a direction of the branch channel, and a reverse electrophoretic velocity component (the direction being perpendicular to the tangent of the boundary of the ion depletion region).

According to an aspect of the present disclosure, as shown in FIG. 1, the direction of the electrophoretic velocity may be formed obliquely to the direction of the drag velocity by inducing the slightly convex ion depletion region 300 so that the direction of the resulting velocity may be set to a direction tangent to the ion depletion region.

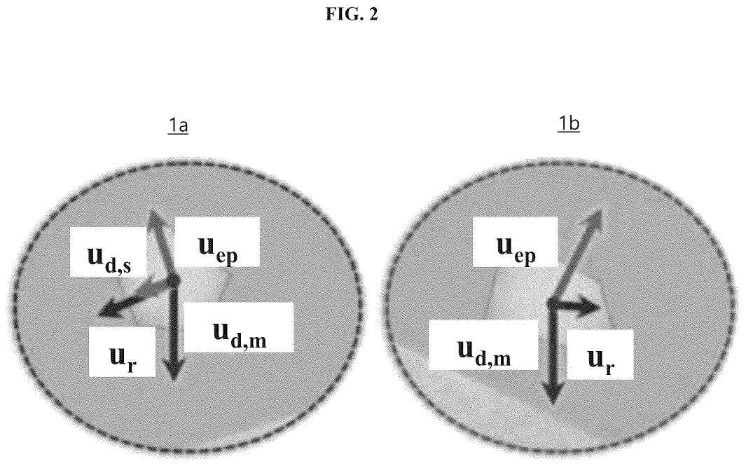

According to an aspect of the present disclosure, the slightly convex ion depletion region 300 is induced as shown in FIG. 1 so that the direction of the electrophoretic velocity is formed obliquely to the direction of the drag velocity, setting the direction of the resultant velocity as the direction tangential to the ion depletion region. As a result, charged particles traveling around the center of the main channel 100 may slide continuously toward the branch channel before entering the physical filter 400, thereby mitigating the accumulation of charged particles in the filter and enabling stable and long-term system operation. FIG. 2 shows the kinematic relationship between a charged particle (la) located at the edge of the main channel and a charged particle (1b) located at the center thereof.

For example, charged particles such as MPs may show rotational behaviors and cross-lateral migrations as well as inertial migrations, as in practice they have random shapes such as plates, rods, discs, etc. However, since these types of particle motions are dominantly observed at high particle Reynolds numbers of ˜10¹-10², they may be neglected in the system representing low particle Reynolds numbers according to the examples of the present disclosure.

Benefiting from easy and accurate manipulation of fine particles, electrokinetic systems have been hired in diverse microfluidic point-of-care diagnostic applications. Unfortunately, however, two fundamental upscaling issues limit the electrokinetic systems' channel sizes to micro-scale, preventing their environmental applications requiring large capacity.

The first issue is to create an electric field (ion depletion region) of uniform direction and intensity throughout the channel width. In a typical microfluidic H-shaped electrokinetic system, the channel size may be limited to hundreds of micrometers as the ion depletion region cannot be evenly extended across the channel width above milli-scale. Correspondingly, the directions of the drag velocity and the electrophoretic velocity may be completely opposite in a microchannel, but may be oblique or even vertical in a wide channel, leading to poor filtration efficiency.

According to an aspect of the present disclosure, it may be possible to overcome this issue by introducing an ion exchange membrane with microholes. For example, the ion depletion region 300 according to an aspect of the present disclosure may include sub-ion depletion regions corresponding to each of the plurality of pores 221 provided in the ion exchange membrane 220 to have a cross-sectional area equal to or larger than a predetermined first area in a direction in which fluid flows. In more detail, the ion exchange membrane with microholes may act as parallelized microchannels bridged by nanochannels, and local ion depletion regions generated in each microchannel may be merged to form an evenly extended ion depletion region in a uniform direction across the channel width. Therefore, unlike the conventional microfluidic electrokinetic systems where the channel size was limited to several hundred micrometers, the ion depletion region 300 of the ion exchange membrane with microholes according to an aspect of the present disclosure may have the cross-sectional area equal to or larger than the predetermined first area in a direction in which fluid flows, e.g., a cross-sectional area over milli-scale in a direction in which fluid flows.

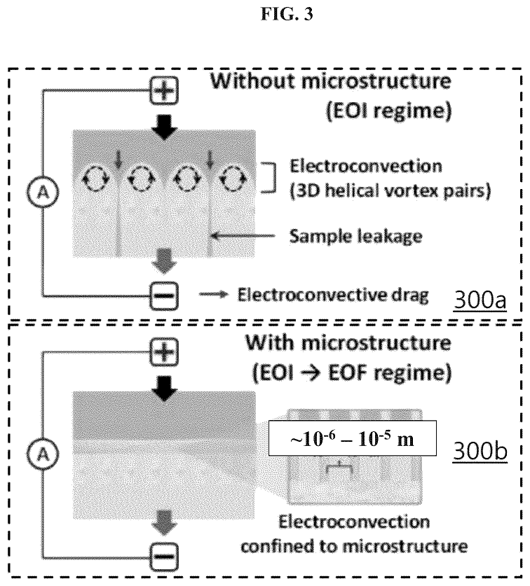

The second issue is to suppress electroconvection (e.g., 3D helical vortex pairs) induced by the electroosmotic instability (EOI) which hinders the formation of a well-distributed electric force barrier in a wide channel. FIG. 3 is a schematic view showing how an ion depletion region is formed in each of the ion exchange membrane alone and the ion exchange membrane-porous layer combination. The overlimiting current may be carried primarily by the EOI with increasing channel size, creating the vigorous electroconvection near the ion exchange membrane. In the case of the filtering apparatus according to an aspect of the present disclosure, when a porous layer 400 is not provided (FIG. 300a), charged particles entering the 3D helical vortex pairs generated near the ion exchange membrane with microholes may move along the streamline, ultimately leaking through the membrane by the electroconvective drag as shown in FIG. 3. According to an aspect of the present disclosure, it may be possible to address this issue by introducing a porous layer which serves as a physical filter for sieving relatively large-sized materials to be filtered, such as large plastic specks. According to an aspect of the present disclosure, in addition to the feature of an electrokinetic-based filtration, the porous layer 400 capable of serving as a physical filter may be further provided. It may be possible for the porous layer 400 to filter out not only charged particles but also uncharged particles as long as the size of the particles is larger than that of the pores of the porous layer 400. The porous layer 400 may also suppress electroconvection in the ion depletion region 300 for electrokinetic-based filtration, as described in detail below.

More specifically, but not exclusively, the filtering apparatus according to an example of the present disclosure may be disposed upstream of the ion exchange membrane 220, and may further include the porous layer 400 designed to filter particles of a size equal to or larger than a predetermined first size among particles in fluid. In the present disclosure, the porous layer may be referred to as a “microstructure.” The porous layer or the microstructure 400 disposed upstream of the ion exchange membrane 220 may confine the electroconvection to micro-scale geometries so that the mechanism for the overlimiting current may be converted from the EOI to electroosmotic flow (see FIG. 300b of FIG. 3). In this manner, it may be possible to realize an even and stable ion depletion region even within a wide channel over centi-scale. That is, the porous layer 400 according to an aspect of the present disclosure may limit electroconvection induced in an ion depletion region to a predetermined level or less, so that the ion depletion region may have a cross-sectional area equal to or larger than a predetermined second area in a direction in which fluid flows. Here, the second area may have an arbitrary number, which may be identical to or different from that of the first area. For example, the second area may be a large area over centi-scale. According to an aspect of the present disclosure, the porous layer 400 may be formed of polyester microfiber, but is not limited thereto.

### Examples

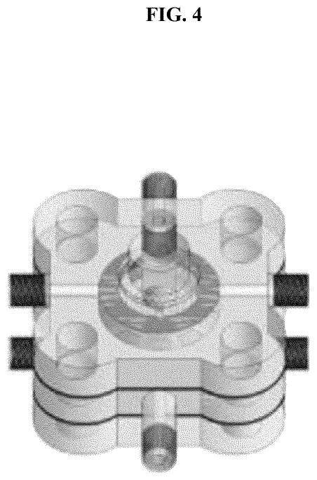

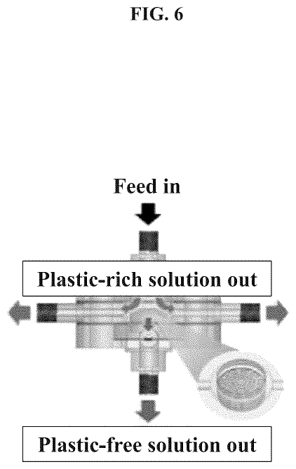

FIG. 4 shows a model experimental device for the filtering apparatus according to an example of the present disclosure, FIG. 5 is an exploded view of the arrangement of main components of the device, and FIG. 6 is a side view of the experimental device in FIG. 4. Components of the experimental device for the filtering apparatus according to an aspect of the present disclosure will be described in detail with reference to FIGS. 4 to 6.

The experimental device may largely consist of top and bottom frames 510 and 540 including electrode buffer channels and a mid-frame 530 including a branch channel. Each frame may have a single hole with a diameter of 1 cm in the center, and the holes may construct a main channel when assembled. The first electrode 210 and the ion exchange membrane 220 may be positioned between the mid-frame 530 and the top frame 510/bottom frame 540, and may have the plurality of pores 211 and 221. The first electrode 210 and the ion exchange membrane 220 may prevent potential damage to the main channel due to by-products of electrode reactions by simultaneously allowing fluid and current to flow. Elastic silicone gaskets 521, 523, and 525 may be stacked with the first electrode 210 to avoid fluid leakage between contact surfaces during device operation. For example, the plurality of silicon gaskets 521, 523, and 525 may be provided between the top frame 510 and the mid-frame 530. For example, the first electrode 210 may be disposed on the middle silicon gasket 523, but is not limited thereto.

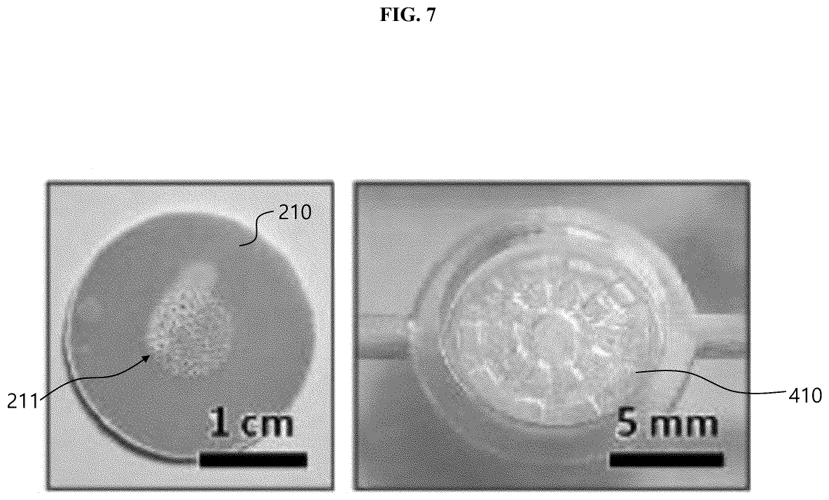

FIG. 7 shows an ion exchange membrane with a microhole array and a porous layer covered with a dorm-shaped cap. For the movement of charged particles as well as a uniform flow distribution in the main channel, the microholes 211 and 221 with a diameter of 400 μm may be densely formed in the first electrode 210 and/or the ion exchange membrane 220. The porous layer 400 or the microstructure formed of PEST microfiber may be installed in the central hole of the mid-frame 530 to sieve relatively large particles and suppress electroconvection below a predetermined level.

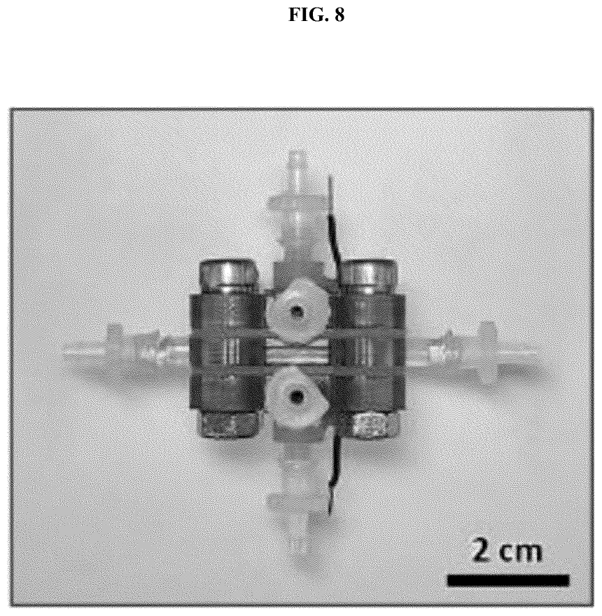

According to an aspect of the present disclosure, a dorm-shaped cap 410 designed to fix the porous layer 400 and allow the flow of fluid may be disposed upstream of the porous layer 400. For example, the dorm-shaped cap 410 may have a plurality of openings to allow fluid to flow. According to an aspect of the present disclosure, in order to induce a convex ion depletion region, the upper boundary of the porous layer 400 may be formed to have a slightly round shape using the dorm-shaped cap 410. More specifically, the upper boundary of the porous layer 400 may be bent by the dorm-shaped cap 410 so that the ion depletion region 300 may have a convex shape. FIG. 8 shows the assembled experimental device. The components of the device may be assembled, for example, with simple screwing as shown in FIG. 8.

### Experiment Example 1—Investigation of MPs Filtration Behavior According to the Relationship Between Voltage and Flux

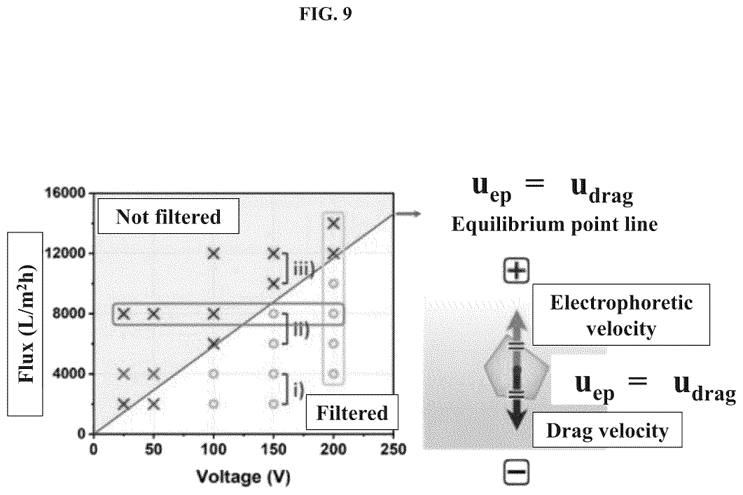

FIG. 9 shows a comparison of MP removal performance shown by mathematical analysis and that shown in experimental results. The description of the ability to remove MPs as an example of charged particles will be provided below. However, it should be noted that materials to be filtered according to the present disclosure are not limited to MPs. FIG. 9 shows an equilibrium point at which drag velocity and electrophoretic velocity cancel out.

As explained earlier, a plastic speck entering an ion depletion region induced in a simple straight channel system has the forward drag velocity and backward electrophoretic velocity. The speck stops in the vicinity of the ion depletion region boundary where the two velocity components cancel each out, which is called an equilibrium point. On the basis of the equilibrium point, the speck moves downward when the drag velocity becomes dominant and upward when the electrophoretic velocity does. As such, it serves as a reference point from which the MPs filtration behavior can be predicted theoretically. Setting equation (2) and (3) equal to each other, a simple linear relationship between voltage and flux is confirmed, depicted as a equilibrium point line in the plot shown in FIG. 9. In theory, based on this line, the upper area is the not-filtered regime where MPs pass through the electric force barrier (u_{drag}>uₑₚ), while the lower area is the filtered regime where the removal efficiency of >99.9% is achieved (u_{drag}=uₑₚ at the ion depletion region boundary). We obtained experimental results of MPs filtration under various voltage-flux conditions and overlaid them on the plot. The experimental conditions showing the removal efficiency of >99.9% were indicated by circle symbols and the others were indicated by cross symbols. The overlaid experimental results show fair correlations with the mathematical analysis, denoting that the hybrid filtration mechanism of the disclosure worked normally.

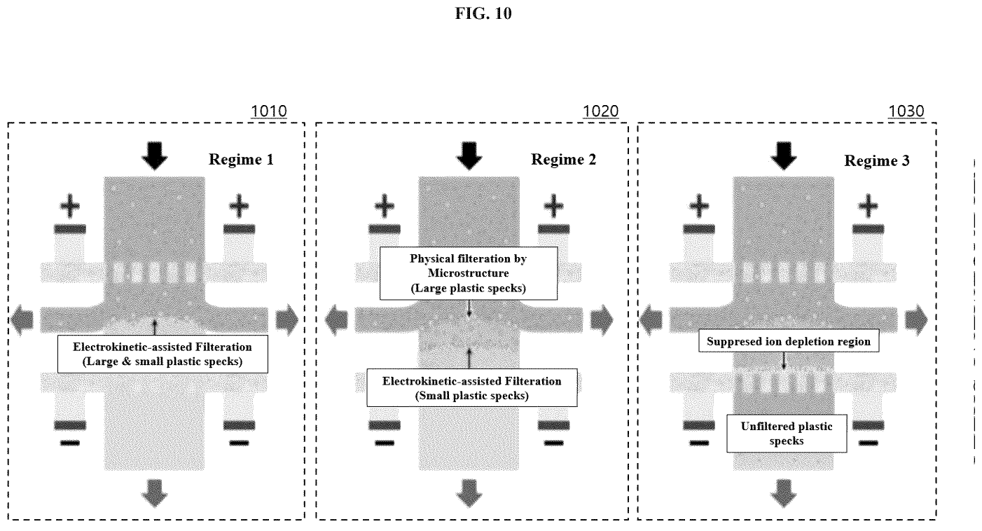

FIG. 10 shows three different filtration regimes distinguished by the relationship between voltage and flux.

Three distinct filtration regimes (Regime 1-3) distinguished by voltage-flux relationships are exhibited in FIG. 10. When the electrophoretic velocity is relatively dominant compared to the drag velocity (Regime 1) 1010, most MPs are electrokinetically filtered by being repelled from the outer boundary of the microstructure, while some MPs are retained in the microstructure.

By slightly increasing flux, the equilibrium point appears in the middle of the microstructure (Regime 2) 1020. In this regime, large plastic specks are physically filtered by the microstructure lattice, and small plastic specks skipping the lattice are electrokinetically trapped at the equilibrium point. Due to MPs being unable to break through the electric force barrier, the complete removal efficiency close to 100% is accomplished in Regime 1 and 2. As flux further increases and therefore the drag velocity overwhelms the electrophoretic velocity (Regime 3) 1030, the equilibrium point no longer appears in the microstructure and the ion depletion region is suppressed to near the CEM-electrolyte interface. Large plastic specks are still physically filtered, but small plastic specks penetrate through the electric force barrier and flow into the filtrate, resulting in low removal efficiency.

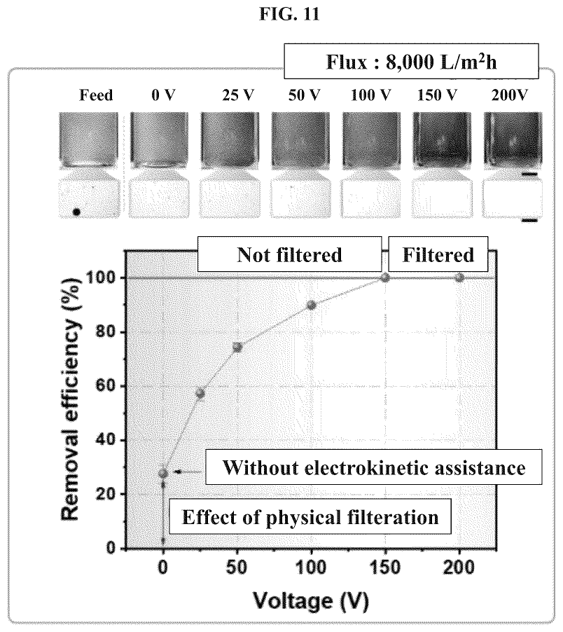

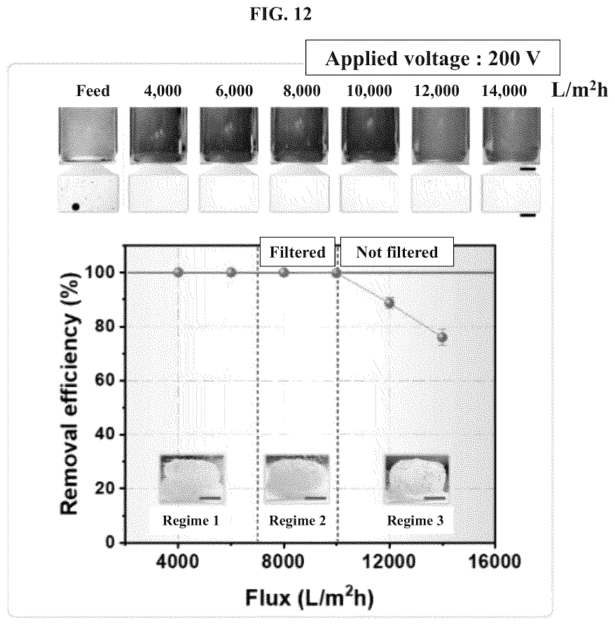

FIG. 11 shows photographs and microscopic images of feed and filtrate of sampled PE microspheres that vary depending on voltage, and removal efficiency for the PE microspheres that varies depending on voltage. In addition, FIG. 12 shows photographs and microscopic images of feed and filtrate of sampled PE microspheres that vary depending on flux, and removal efficiency for the PE microspheres that varies depending on flux. The scale bars in the photographs and microscope images represent 6 mm and 500 μm, respectively. The pictures in the graph in FIG. 12 show various patterns of accumulation of PE microspheres in the microstructure in fluxes of 6,000 L m⁻² h⁻¹ (Regime 1), 8,000 L m⁻² h⁻¹ (Regime 2), and 12,000 L m⁻² h⁻¹ (Regime 3), and the scale bars represent 4 mm.

FIG. 11 shows filtration performance for MPs with a function of voltage, and FIG. 12 shows filtration performance for MPs with a function of flux.

It can be seen in FIG. 11 that the removal efficiency of 27.6% is achieved without voltage applied, which is entirely due to the physical filtration of large and a few small particles. The effect of the physical filtration is the same under voltage applied conditions, supported by the microscopic images of filtrates showing the absence of large particles. When voltage increases under a constant flux of 8,000 L m⁻²h⁻¹, the removal efficiency increases as the electrokinetic assistance is gradually enhanced, reaching >99.9% under voltage conditions of 150 V or higher.

In a contrasting manner, an increase in flux under a constant voltage of 200 V causes a decrease in the removal efficiency in FIG. 12. The removal efficiency of >99.9% is confirmed under flux conditions of up to 10,000 L m⁻²h⁻¹, decreasing to 88.7% and 76.0% as flux increases respectively to 12,000 L m⁻²h⁻¹ and 14,000 L m⁻²h⁻¹. Regime 1-3 described above can be distinguished by the distributions of accumulation of particles in the microstructure formed during the system operation. As shown in the inset images in FIG. 12, particles are mainly accumulated on the top surface of the microstructure at a flux of 6,000 L m⁻²h⁻¹, while the accumulation zone is extended to a deeper position at a flux of 8,000 L m⁻²h⁻¹. These distribution behaviors correspond to Regime 1 and Regime 2 of FIG. 10, and consequently, it can be expected that the point of the regime shift from Regime 1 to Regime 2 exists at a specific flux between 6,000 L m⁻²h⁻¹ and 8,000 L m⁻²h⁻¹. The critical flux of the regime shift from Regime 2 to Regime 3 where MPs start to penetrate through the electric force barrier also can be easily inferred as 10,000 L m⁻²h⁻¹ in which the removal efficiency begins to decrease.

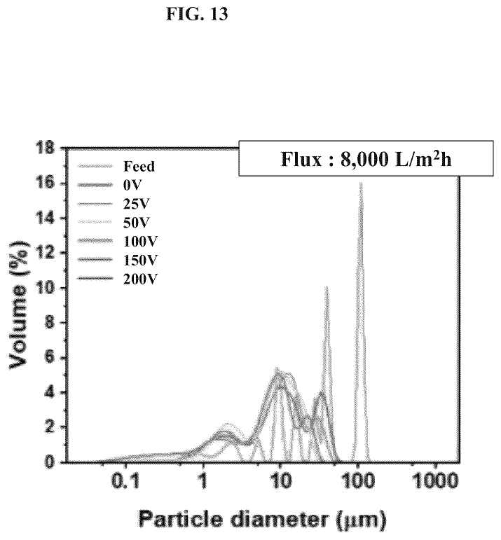

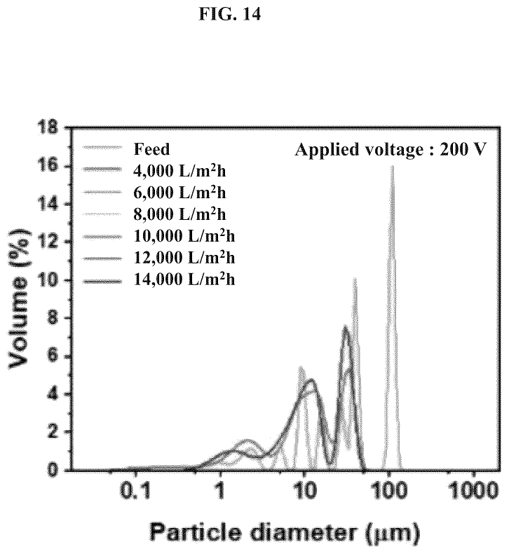

FIG. 12 shows the photos and microscopic image of the filtrates for varying flux conditions. As with the filtrates for varying voltage conditions, no large particles were observed due to the physical filtration. The particle size distributions of PE microspheres in the filtrates for different voltage and flux conditions are shown in FIG. 13 and FIG. 14, respectively.

That is, FIG. 13 shows the proportion of particles of each size in feed and filtrate of PE microspheres for each voltage, and FIG. 14 shows the proportion of particles of each size in feed and filtrate of PE microspheres for each flux.

Herein, it was confirmed that particles with different size distributions were evenly dispersed in the feed. On the other hand, particles with a size distribution of 250-300 μm were unobservable in the plot, presumably because the number (or concentration) of them was lower than the analytical detection limit. Through the physical filtration alone (0 V), all particles >50 μm were removed and the proportion of particles larger than tens of micrometers was also significantly reduced. For a voltage condition of 25 V, the proportion of particles with a size distribution of 20-45 μm was reduced while that of particles with a size of ˜ 10 μm increased, which was due to the electrokinetic assistance. With increasing voltage, the proportion of relatively large particles was reduced and that of small particles increased. This aspect of change may be attributed to zeta potential being proportional to particle size for identical type of particles. Notably, the distributions for voltage conditions of 150 V or higher where the removal efficiency of >99.9% was confirmed were expressed as a zero baseline because both filtrates contained particle counts below the analytical detection limit. For the same reason, the distributions for flux conditions of 4,000-10,000 L m⁻²h⁻¹ were expressed as a zero baseline. As flux increased, the proportion of small particles was reduced and that of relatively large particles increased, which was the exact opposite of the change in distribution according to an increase in voltage.

### Experiment Example 2—Effect of Zeta Potential on MPs Removal Performance

In order to clarify the electrokinetic-assisted filtration mechanism based on MPs' electrophoretic mobility, the proposed system's filtration performance for the same type of MPs with different zeta potentials under various pH conditions was investigated. In this study, three specific pH conditions; pH 4, 7, and 10 were chosen to keep the buffers' electrolyte concentrations at a certain level between 0.1 mM and 1 mM. Also, PS microspheres with a diameter of 6 μm negatively charged in the corresponding pH range were used, whose zeta potentials in pH 4, 7, and 10 buffer were −5.95±0.47, −28.5±0.50, and −31.7±0.58 mV, respectively. The concentration of MPs in each feed was all set to 0.2 g/L.

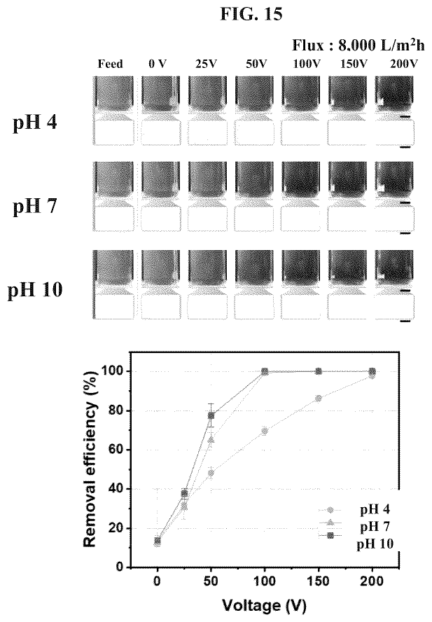

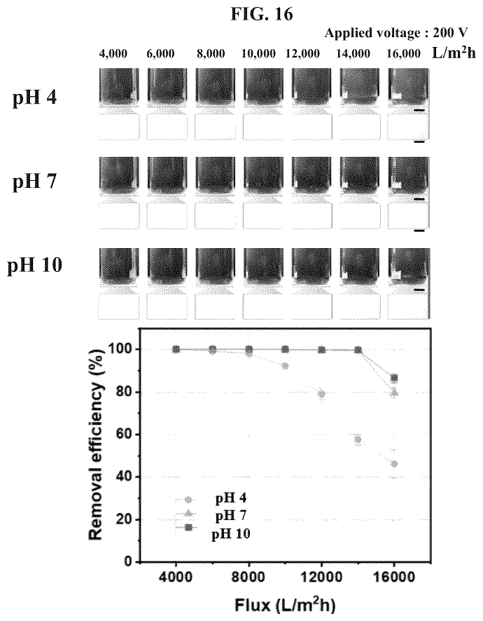

FIG. 15 shows photographs and microscope images of feed and filtrate under various pH conditions that vary depending on voltage and removal efficiency for PS microspheres under various pH conditions that varies depending on voltage, and FIG. 16 shows photographs and microscope images of feed and filtrate under various pH conditions that vary depending on flux and removal efficiency for the PS microspheres under various pH conditions that varies depending on flux. In other words, the figures show photographs and microscopic images of feed and filtrate of PS microspheres under various pH conditions (pH 4, 7, and 10) sampled for the study where voltage and flux are controlled. The scale bars in the photographs and the images represent 6 mm and 250 μm, respectively. Hereinafter, the effect of zeta potential on MP removal performance will be described with reference to FIGS. 15 and 16.

At first, FIG. 15 and FIG. 16 illustrate the photos and microscopic images of filtrates for various pH conditions according to voltage and flux change. The aspect of change in concentration of MPs in filtrates, which decreases or increases with increasing voltage and flux, proves that MPs experienced the repulsive electrophoretic force in the system irrespective of pH conditions, underpinned by the fact that all of them are negatively charged when suspended in the buffers. As predicted theoretically, separate filtration behaviors are observed in MPs with different zeta potentials, because the degree of the electrokinetic assistance entirely depends on the magnitude of MPs' electrophoretic mobility. The removal efficiency distributions clearly distinguished by zeta potential of MPs were confirmed in FIG. 15 and FIG. 16. As can be seen from equation (2), since the electrophoretic velocity is proportional to the electric field and zeta potential of MPs, the same degree of voltage change results in a greater velocity change in MPs with larger zeta potential. Consequently, it is obvious that zeta potential has a positive correlation with the removal efficiency considering the characteristic of the electrokinetic assisted filtration mechanism. In the case of MPs in pH 4 buffer with the smallest zeta potential, the removal efficiency gradually increases as voltage increases, reaching 97.8% at a voltage of 200 V. The removal efficiency for MPs in pH 7 buffer is similar to that for MPs in pH 4 buffer at a voltage of 25 V, but more steeply increases as voltage increases, ending up reaching a plateau (>99.9%) at a voltage of 150 V. The steepest incline is observed in the removal efficiency curve for MPs in pH 10 buffer with the largest zeta potential. As a result, it reaches the plateau first at a voltage of 100 V. Meanwhile, there is very little difference in the effect of the physical filtration under the entire pH conditions as identical MPs were tested; the removal efficiencies for MPs in pH 4, 7, and 10 buffer are 13.5%, 12.7%, and 13.8% respectively. The aspect of change in the removal efficiency according to flux change is also mainly influenced by the magnitude of MPs' electrophoretic mobility. The magnitude of the electrophoretic velocity varies in proportion to zeta potential of MPs. With increasing flux, MPs with the smallest zeta potential first get into Regime 3, beginning to leak downstream. Unlike the case of voltage change, however, flux has no significant effect on the rate of change of the removal efficiency and only determines the initiation of MPs leakage, due to being a variable independent of the electrophoretic velocity. The removal efficiency for MPs in pH 4 buffer is >99.9% only at a flux of 4,000 L m⁻²h⁻¹ and then falls by 46.3% as flux increases to 16,000 L m⁻²h⁻¹, whereas those for MPs in pH 7 and 10 buffer maintain the plateau up to a flux of 14,000 L m⁻²h⁻¹. Corresponding to the aforementioned assumption, it is confirmed that there is no close relation between the decline rate of the removal efficiency and zeta potential of MPs. The same critical flux confirmed in MPs in pH 7 and 10 buffer with different zeta potentials is supposedly due to large flux variation of 2,000 L m⁻²h⁻¹ in this study. Thus, It is estimated that distinguished critical fluxes actually exist between 14,000 L m⁻²h⁻¹ and 16,000 L m⁻²h⁻¹ for MPs in pH 7 and 10 buffer, and that for MPs in pH 7 buffer with lower zeta potential would be a little bit lower than that for MPs in pH 10 buffer. In this study, the effect of MPs' electrophoretic mobility on the filtration performance in the hybrid filtration system is thoroughly demonstrated through experimental verification. The experimental results show that the operating condition at which the optimal removal efficiency appears depends on zeta potential of MPs. In this respect, adjusting zeta potential of MPs appropriately would be helpful to achieve faster and more effective MPs removal in the proposed system.

### Experiment Example 3—Filtration Performance for Various Types of MPs

We evaluated the proposed system's filtration performance for three different types of MPs (PE, PS, and PP), which are most frequently found in aquatic environments. Each feed contains PE microspheres with a diameter of 10-45 μm, PS microspheres with a diameter of 20 μm, and PP fragments with a size of 25-85 μm, homogeneously dispersed in 1 mM NaCl electrolyte at a concentration of 0.2 g/L. The zeta potentials of PE microspheres, PS microspheres, and PP fragments were −12.5±0.79, −25.7±0.82, and −6.29±0.98 mV, respectively.

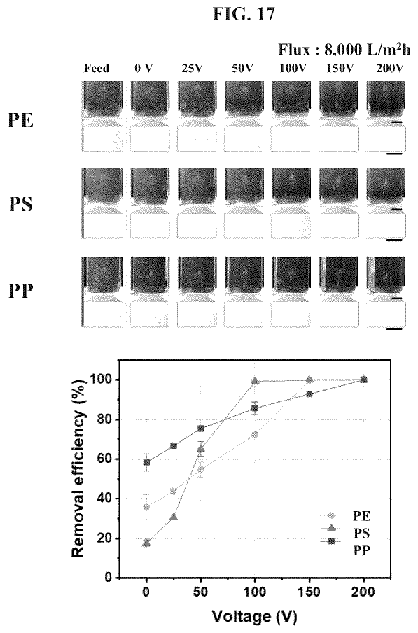

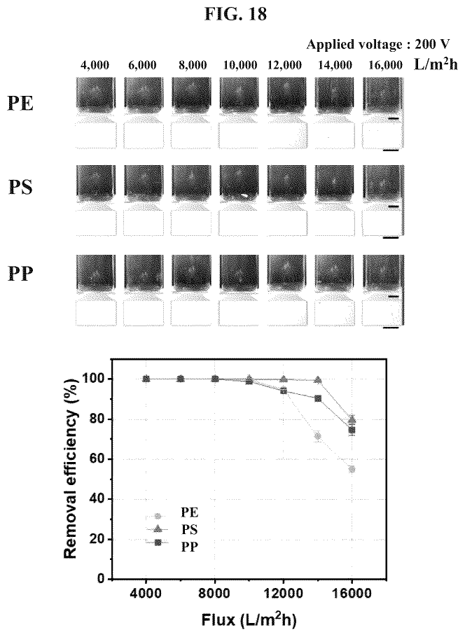

FIG. 17 shows photographs and microscopic images of feed and filtrate of sampled PE, PS, and PP microspheres that vary depending on voltage and removal efficiency for the PE, PS and, PP microspheres that varies depending on voltage, and FIG. 18 shows photographs and microscopic images of feed and filtrate of sampled PE, PS, and PP microspheres that vary depending on flux and removal efficiency for the PE, PS, and PP microspheres that varies depending on flux. The scale bars in the photographs and the images represent 6 mm and 500 μm, respectively. Hereinafter, the description of filtration performance for various types of MP will be provided with reference to FIGS. 17 and 18.

The filtration behaviors for each type of MPs according to voltage and flux change are differentiated by the magnitude of zeta potential of MPs, as shown in FIG. 17 and FIG. 18. PS microspheres with the largest zeta potential were not visually observed in filtrates under voltage conditions of 100 V or higher and began to leak into filtrates at a flux of 16,000 L m⁻²h⁻¹. On the other hand, PP fragments with the smallest zeta potential were observable in filtrates even up to a voltage of 150 V and introduced into filtrates under flux conditions of 10,000 L m⁻²h⁻¹ or higher. The removal efficiency distributions corresponding to the microscopic observations are illustrated in FIG. 17 and FIG. 18. With increasing voltage, the highest and lowest increase rate of the removal efficiency are confirmed for PS microspheres and PP fragments, respectively. Accordingly, the larger the zeta potential, the lower the voltage at which the removal efficiency curve reaches the plateau. The effect of the physical filtration is the greatest for PP fragments (58.4%), followed by PE microspheres (35.7%) and PS microspheres (17.6%), which is presumably attributed to differences in their average size distributions. The critical fluxes for PP fragments, PE microspheres, and PS microspheres are 8,000, 10,000, and 14,000 L m⁻²h⁻¹ respectively, exhibiting a proportional relationship with zeta potential. The removal efficiencies for PE microspheres, PS microspheres, and PP fragments decrease respectively to 55.0%, 79.6%, and 74.6% as flux increases to 16,000 L m⁻²h⁻¹. Notably, it can be seen that the decrease rate of the removal efficiency for PP fragments is lower than those for the other MPs, probably due to a high level of the physical filtration effect. The results of this study demonstrate that the MPs removal performance is not significantly related to the type of MPs and is dependent on zeta potential of MPs. In the hybrid filtration method, all of the most dominant types of MPs present in aquatic environments; PE, PS, and PP are able to be effectively removed with the removal efficiency of >99.9% when voltage and flux are adequately balanced. Given the unique electrokinetic-assisted filtration mechanism, it should be understood that the proposed method can be applied not only to MPs herein investigated but to other types of charged MPs.

### Experiment Example 4—Removal of Microfibers

The microfiber mainly shedded during synthetic textile washing is the most dominant shape of MPs present in aquatic environments, critical for successful treatment of MPs. Membrane and filter-based methods such as membrane bioreactor, disc filter, and reverse osmosis have shown some complexity in the complete removal of fiber MPs because they longitudinally penetrate through narrow lattices or small pores. Fundamentally, the proposed hybrid filtration method will not undergo this kind of fiber MPs leakage as the electric force barrier works consistently relying solely on the electrophoretic mobility regardless of MPs' shapes.

Accordingly, the hybrid filtration apparatus according to an aspect of the present disclosure may be used to filter fluid that has passed through a reverse osmosis-based filtration apparatus again.

To verify this, we studied the proposed system's filtration performance for the most common fiber MPs (PEST, Acrylic, and Nylon) in aquatic environments. PEST, Acrylic, and Nylon flocks with a diameter of 10-30 μm and a length of 250 μm were employed as model fiber MPs, homogeneously dispersed in 1 mM NaCl electrolyte at a concentration of 0.2 g/L. The zeta potentials of PEST, Acrylic, and Nylon flocks were −9.94±0.18, −3.24±0.61, and −7.60±0.26 mV, respectively.

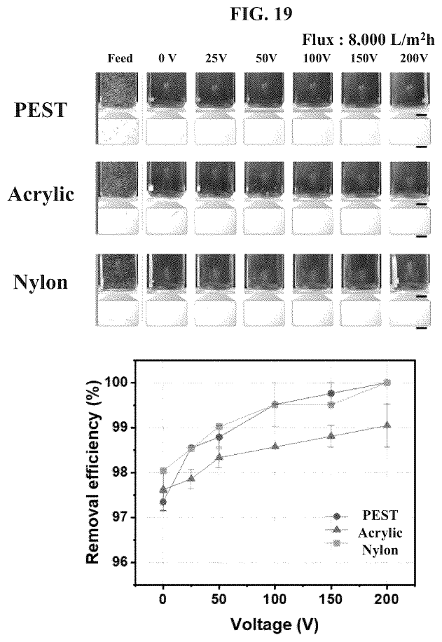

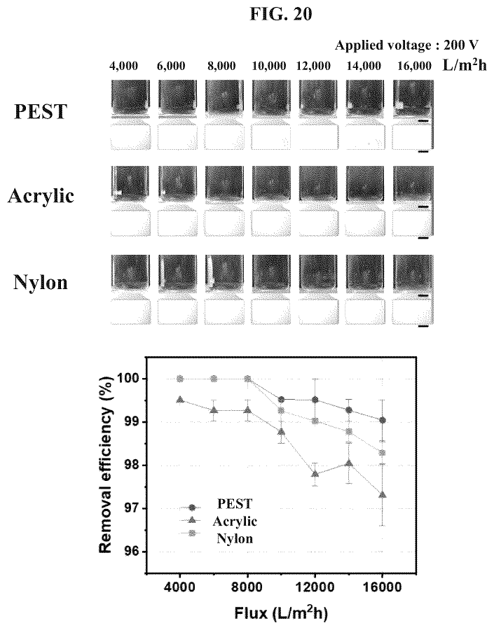

FIG. 19 shows photographs and microscopic images of feed and filtrate of sampled PEST, acrylic, and nylon bundles that vary depending on voltage, and removal efficiency for the PEST, acrylic, and nylon bundles that varies depending on voltage, and FIG. 20 shows photographs and microscopic images of feed and filtrate of sampled PEST, acrylic, and nylon bundles that vary depending on flux, and removal efficiency for the PEST, acrylic, and nylon bundles that varies depending on flux. Hereinafter, the removal of microfibers by the filtration system according to an aspect of the present disclosure will be described in more detail with reference to FIGS. 19 and 20. The scale bars in the photographs and the images represent 6 mm and 1 mm, respectively.

FIG. 19 and FIG. 20 show the photos and microscopic images of filtrates for PEST, Acrylic, and Nylon flocks according to voltage and flux change. Noticeably, a significant number of fibers and fragments smaller than several tens of micrometers, which originated from flocks, were distributed in feed and filtrates. Without voltage applied, most of the flocks were removed by physical filtration as the effective pore size of the microstructure (82.6±0.21 μm) is far smaller than the average size of flocks (250 μm in length), but a majority of fine fibers passed through the filter lattice and then flowed into filtrates. As the voltage increased, the electric force barrier blocked their migrations, resulting in a gradual decrease in the number of fine fibers leaked. In contrast, an increase in flux allowed fine fibers to break through the electric force barrier, incurring the removal efficiency drop.

FIG. 19 and FIG. 20 present the removal efficiency distributions varied with voltage and flux. Not surprisingly, the high removal efficiencies of 97.3-98.0% are attained in all types of fiber MPs without voltage applied due to flocks accounting for most of the mass of samples suspended in feeds. As the average sizes of each type of fiber MPs are similar, the effect of the physical filtration is almost identical for them. The change in the removal efficiency according to an increase in voltage is largely dependent on zeta potential of MPs.

At a voltage of 200 V, the removal efficiencies for PEST and Nylon flocks with relatively large zeta potential are >99.9%, while that for Acrylic flocks with low zeta potential is only 99.0%. In the same manner, the aspect of change in the removal efficiency according to an increase in flux also differs depending on zeta potential of MPs. For PEST and Nylon flocks, the removal efficiencies are found to be >99.9% up to a flux of 8,000 L m⁻²h⁻¹, slightly decreasing to 99.0% and 98.3% respectively at a flux of 16,000 L m⁻²h⁻¹. For Acrylic flocks, Regime 3 already prevails from a flux of 4,000 L m⁻²h⁻¹ and the removal efficiency decreases to 97.3% as flux increases to 16,000 L m⁻²h⁻¹. As mentioned earlier, the low removal efficiency resulting from low zeta potential can be resolved by increasing zeta potential of MPs through the adjustment of the feed's pH condition. Taken together, the electrokinetic assistance effectively prevents leakage of tiny plastic fibers, enabling the successful removal of fiber MPs. In addition, this study confirms that the proposed system shows consistent filtration performance regardless of MPs' shapes, demonstrating the unique characteristic of the hybrid filtration mechanism again.

As examined above, the filtration efficiency of the apparatus for filtering charged particles according to an example of the present disclosure may vary depending on at least one of the flow rate of fluid passing through the filtration apparatus, voltage applied to the first electrode and the ion exchange membrane, zeta potential of charged particles, or the type of charged particles.

In this regard, a highly efficient, fast, and scalable filtration system for MPs removal from wastewater by integrating electrokinetic assistance into physical filtration is described. By inducing an electric force barrier in a physical filtration system, we revealed that an intrinsic efficiency-flux trade-off can be greatly mitigated as it prevents downstream migrations of MPs passing through a filter lattice. With the electrokinetic assistance, a high removal efficiency of >99.9% and a flux of 10,000 L m⁻²h⁻¹ were achieved for MPs without applying high pressure in spite of using a filter with an average pore size of tens of micrometers. The experimental results demonstrated that the filtration performance of the proposed method only depends on MPs' electrophoretic mobility, allowing successful treatment of MPs regardless of their types, sizes, shapes, and chemical compositions.

Based on the nature of the electrophoretic force-based filtration mechanism, the proposed method also exhibited the same filtration behaviors in varying MPs' concentrations and was free from blockage of filter pores during device operation. These unique characteristics differentiate the proposed method from typical MF technologies reporting inconsistent filtration performances and inevitable membrane fouling issues.

### Experimental Section

### Preparation of Artificial MPs Solutions

The artificial MPs solutions used in the filtration experiments were prepared by dispersing a single type of MPs in deionized (DI) water. In the hybrid filtration system's core operating parameter studies, a feed containing PE microspheres having four different size ranges with a diameter of 0.2-10 μm, 10-45 μm, 95-115 μm, and 250-300 μm (Cospheric LLC, USA) was used. The concentration of MPs with each size range was the same at 0.1 g/L (total MPs concentration: 0.4 g/L). In the other studies, feeds containing a single size range of MPs were used and the concentration of MPs in each feed was identical at 0.2 g/L. The feeds used in the study to determine the effect of zeta potential of MPs on the proposed system's filtration behavior were prepared by dispersing 6 μm diameter PS microspheres (Polysciences, USA) in buffers with various pH conditions (pH 4, 7, and 10). PE microspheres (diameter: 10-45 μm), PS microspheres (diameter: 20 μm), and PP fragments (diameter: 25-85 μm) (Polysciences, USA) were chosen as model types of MPs in the study on the evaluation of the proposed system's filtration performance for different types of MPs. In order to demonstrate the proposed system's efficacy for fiber MPs, PEST (diameter: 10-30 μm), Acrylic (diameter: 19-25 μm), and Nylon flocks (diameter: 10-20 μm) (Goonvean Fibres ltd, UK) were tested. They had the same length of 250 μm. For stable aqueous suspension of MPs, a non-ionic surfactant Tween 20 (Cospheric LLC, USA) was added to the artificial MPs solutions at a concentration of 0.1% w/v. Together, the electrolyte concentration of the artificial MPs solutions was adjusted to 1 mM with sodium chloride (NaCl, Sigma Aldrich, USA) to induce electrokinetic phenomena in the system. The pH of buffers used in the study to determine the effect of zeta potential of MPs on the proposed system's filtration behavior was adjusted with hydrochloric acid (HCl, Sigma Aldrich, USA) and sodium hydroxide (NaOH, Sigma Aldrich, USA).

### Fabrication of Scalable Electrokinetic-Assisted Filtration Device

A simple assembly-based scalable electrokinetic-assisted filtration device is devised for experimental regarding a filtration device of the disclosure. The top, bottom, and mid-frame of the device including the main channel, buffer channels, and branch channel were fabricated by 3D printing (Object3500 with Vero clear material, Stratasys, USA). 1 mm thick carbon paper electrodes were cut into a ring shape using paper punches, inserted into slots of the top and bottom frame and fixed using a silver conductive epoxy adhesive (MG Chemicals 8330, MG Chemicals, Canada). For DC electricity application, titanium wires were firmly attached to the carbon paper electrodes. Micro holes in CEMs were prepared by a simple drilling process. The micro hole array, with 400 μm diameter holes and 500 μm spacing between holes, was formed in commercial CEMs (Fumasep, FTCM-E, Germany) using a desktop engraving machine (DE-3 Desktop Engraver, Roland DF, Japan). After forming the micro hole array, the CEMs were cut into a circular shape using a paper punch. Silicone gaskets for preventing fluid leakage were prepared by cutting a 0.5 mm thick silicone sheet (HSW, South Korea) using a laser cutter (Universal Laser System, USA). The main channel of the mid-frame was compactly filled with a microstructure (PEST microfiber, Huvis, South Korea), then covered with a 3D-printed dorm-shaped cap to induce a convex ion depletion region. Finally, all device components were aligned as shown in FIG. 1f, assembled by screw fastening. For fluid flow control in the device, barbed tubing connectors (Harvard Apparatus, USA) were mounted on the frames' inlets and outlets.

### Filtration Experiments

The experimental procedure in the electrokinetic-assisted filtration system is as follows: Prior to experiments, the CEMs were soaked in DI water for 5 min for smooth current flow between the main channel and buffer channels. The feed reservoir and buffer reservoirs were connected respectively to each inlet of the main channel and buffer channels by silicone tubings (Cole-Parmer, USA), and 0.3 M of sodium sulfate (Na2SO4, Samchun, South Korea) was used as electrode buffer. Luer-Lok syringes (BD Luer-Lok, BD, USA) were connected to tubing connectors mounted on the outlets of the main channel and branch channel by silicon tubing, and specific withdrawal flow rates were applied to the outlets using syringe pumps (PHD 2000, Harvard Apparatus, USA). A constant DC electric field was applied to working electrodes using a source measure unit (B2902A, Keysight, USA). A detailed experimental setup is illustrated in Figs. S7 and S8. In order to obtain reliable filtrates unaffected by MPs leakage caused before generating the electric force barrier, feed introduction was preceded by the ion depletion region formation. First, 1 mM of NaCl not containing MPs was filled in the main channel. Then, the feed reservoir was connected to the main channel's inlet while maintaining the negative pressure by confining the outlets of the main channel and branch channel to prevent downstream migration of MPs. In this state, electricity was applied to the system to induce the ion depletion region near the cathode-side CEM, followed by allowing fluid flow. Filtrates collected in Luer-Lok syringes connected to the outlets of the main channel and branch channel were gently extracted in conical tubes.

### Determination and Characterization of MPs

The microscopic method and infrared method have been widely used to quantify and characterize MPs in aquatic environments due to their high reliability, but are cumbersome and time-consuming when analyzing numerous and complex samples. In this study, the weighting method was adopted to determine the removal efficiency in the electrokinetic-assisted filtration system rather than those methods as artificial MPs solutions used in each experiment consisted of a single type of MPs. The detailed procedures were as follows: First, the feeds and filtrates were filtered with 0.22 μm hydrophilic membrane filters (Millipore, USA). Then, the retrieved membrane filters were covered with aluminum foils to prevent the inflow of foreign matters and subsequently dried in vaccum drying oven at 60° C. for 24 h. Since there were very small amounts of MPs in each feed and filtrate, the mass of the membrane filter was measured using a 5-digit high precision balance with readability down to 0.01 mg (MS105, METTLER TOLEDO, USA).

The mass of MPs was calculated by subtracting the mass of the bare membrane filter from that of the MPs-accumulated membrane filter. The removal efficiency in the electrokinetic-assisted filtration was calculated by the following equation (4):

$$Removal efficiency ( \% ) = 100 \% \times \frac{{m}_{F} - {m}_{f}}{{m}_{F}} \qquad ( 4 )$$

where mF is the mass of MPs in feed and mf is the mass of MPs in filtrate.

All experiments were conducted twice and the average values of two samples were recorded.

The microstructure morphology was observed using a multi-focus optical microscope (BX53M, Olympus, Japan) and a scanning electron microscope (SU6600, Hitachi, Japan), and its mean pore size was calculated using ImageJ software (NIH, Bethesda, MD, USA). The digital microscopic images of feeds and filtrates were acquired by an inverted fluorescent microscope (IX71, Olympus, Japan) and microscopy imaging software (cellSens, Olympus, Japan). The particle size distributions of PE microspheres were analyzed by a laser diffraction particle size analyzer (LS 13 320, Beckman Coulter, USA). The zeta potential of MPs was measured by a zeta potential & particle size analyzer (ELSZ-2000, Otsuka Electronics, Japan).

Although the above has been described with reference to the drawings and examples, it does not mean that the scope of protection of the present disclosure is limited by the drawings or examples, and those skilled in the art will understand the scope of the present disclosure described in the claims below. It will be understood that various modifications and changes can be made to the present disclosure within the scope not departing from the spirit and area.

Although the present disclosure described above has been described based on a series of functional blocks, it is not limited by the above-described embodiments and it will be clear to those skilled in the art that various substitutions, modifications, and changes are possible within the scope of the technical idea of the present invention.

Combinations of the above-described embodiments are not limited to the above-described embodiments, and various types of combinations may be provided as well as the above-described embodiments according to implementation and/or needs.

In the foregoing embodiments, the methods are described on the basis of a flow chart as a series of steps or blocks, but the present disclosure is not limited to the order of steps, and some steps may occur in a different order or concurrently with other steps as described above. In addition, those skilled in the art will understand that the steps illustrated in the flow chart are not exclusive, that other steps may be included, or that one or more steps of the flow chart may be deleted without affecting the scope of the present disclosure.

The foregoing embodiment includes examples of various aspects. It is not possible to describe all possible combinations to represent the various aspects, but those skilled in the art will recognize that other combinations are possible. Accordingly, it is intended that the present disclosure cover all other substitutions, modifications and variations falling within the scope of the following claims.

What is claimed is:

1. An electrokinetic-based apparatus for filtering charged particles, comprising:
a main channel through which a fluid containing charged particles is injected and flows;
a first electrode disposed to allow the flow of fluid inside the main channel; and
an ion exchange membrane disposed downstream of the first electrode and having a plurality of pores through which the fluid from which the charged particles have been filtered is discharged.

2. The apparatus for filtering charged particles of claim 1, wherein the first electrode and the ion exchange membrane generate an electric field therebetween.

3. The apparatus for filtering charged particles of claim 2, wherein a polarity different from that of charged particles to be filtered is applied to the first electrode, the ion exchange membrane is an ion exchange membrane for ions of a polarity different from that of charged particles to be filtered, and a second electrode having the same polarity as charged particles to be filtered is connected to the ion exchange membrane.

4. The apparatus for filtering charged particles of claim 3, wherein an ion depletion region is formed upstream of the ion exchange membrane to block the movement of the charged particles into the pores of the ion exchange membrane.

5. The apparatus for filtering charged particles of claim 4, wherein the ion depletion region is formed based on ion concentration polarization (ICP).

6. The apparatus for filtering charged particles of claim 1, wherein the first electrode includes an additional ion exchange membrane having a plurality of pores allowing the flow of fluid.

7. The apparatus for filtering charged particles of claim 4, wherein the ion depletion region causes an electrophoretic force to act on the charged particles.

8. The apparatus for filtering charged particles of claim 7, wherein the charged particles move in a direction different from a direction in which fluid flows by a drag force resulting from the flow of the fluid and the electrophoretic force.

9. The apparatus for filtering charged particles of claim 4, wherein the ion depletion region includes sub-ion depletion regions corresponding to each of the plurality of pores in the ion exchange membrane and has a cross-sectional area equal to or larger than a predetermined first area in a direction in which fluid flows by including the plurality of sub-ion depletion regions.

10. The apparatus for filtering charged particles of claim 4, further comprising a porous layer disposed upstream of the ion exchange membrane inside the main channel and designed to filter particles of a size equal to or larger than a predetermined first size among particles in fluid.

11. The apparatus for filtering charged particles of claim 10, wherein the porous layer limits electroconvection induced in the ion depletion region to a predetermined level or less so that the ion depletion region has a cross-sectional area equal to or larger than a predetermined second area in a direction in which fluid flows.

12. The apparatus for filtering charged particles of claim 11, wherein the electroconvection is induced by electroosmotic instability.

13. The apparatus for filtering charged particles of claim 11, wherein the electroconvection includes a three-dimensional helical vortex pair.

14. The apparatus for filtering charged particles of claim 10, wherein the porous layer is formed of polyester microfiber.

15. The apparatus for filtering charged particles of claim 10, further comprising a dorm-shaped cap designed to fix the porous layer and allow the flow of fluid.

16. The apparatus for filtering charged particles of claim 15, wherein the upper boundary of the porous layer is bent by the dorm-shaped cap so that the ion depletion region has a convex shape.

17. The apparatus for filtering charged particles of claim 1, wherein the filtration efficiency of the apparatus for filtering charged particles varies depending on at least one of the flow rate of fluid passing through the filtration apparatus, voltage applied to the first electrode and the ion exchange membrane, zeta potential of the charged particles, or the type of the charged particles.

18. The apparatus for filtering charged particles of claim 1, wherein the apparatus for filtering charged particles is used to filter again fluid that has passed through a reverse osmosis-based filtration apparatus.

19. The apparatus for filtering charged particles of claim 1, further comprising a branch channel diverging from the main channel upstream of the ion exchange membrane and allowing the charged particles to be discharged therethrough.

20. The apparatus for filtering charged particles of claim 19, wherein the charged particles are sent to the branch channel by a resultant force of the electrophoretic force of the ion depletion region formed upstream of the ion exchange membrane and a drag force resulting from the flow of fluid.
